(19) United States
(12) Patent Application Publication
(10) Pub. No.: US 2022/0058441 A1
(43) Pub. Date: Feb. 24, 2022

(54) INFORMATION PROCESSING DEVICE, INFORMATION PROCESSING METHOD, AND INFORMATION PROCESSING SYSTEM

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventor: Topon PAUL, Kawasaki Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 17/196,807

(22) Filed: Mar. 9, 2021

(30) Foreign Application Priority Data
Aug. 21, 2020 (JP) 2020-140400

(51) Int. Cl. G06K 9/62; G06N 3/08; G06N 7/00

(52) U.S. Cl. CPC G06K 9/6261; G06K 9/6257; G06K 9/6201; G06N 7/005; G06K 9/6227; G06N 3/08; G06K 9/6228

(57) ABSTRACT

According to one embodiment, an information processing device includes: a divider configured to divide time series data of an objective variable into a plurality of first sections based on values of the objective variable; a model generator configured to generate, based on time series data of an explanatory variable and the time series data of the objective variable, a plurality of prediction models in which the explanatory variable and the objective variable are associated, for the plurality of first sections; a selector configured to select a first section from the plurality of first sections based on at least one of the time series data of the explanatory variable and the time series data of the objective variable; and a predictor configured to predict the value of the objective variable by using the prediction model generated for the selected first section.

### CROSS REFERENCE TO RELATED APPLICATIONS

This application is based upon and claims the benefit of priority from the prior Japanese Patent Application No. 2020-140400, filed on Aug. 21, 2020, the entire contents of which are incorporated herein by reference.

### FIELD

Embodiments described herein relates to an information processing device, an information processing method, a computer program, and an information processing system.

### BACKGROUND

In the fields of weather forecast, abnormal weather forecast, disaster prevention, renewable energy, hydroelectric power, stock price, risk analysis, and the like, it is a common practice to predict future values of objective variables after a specific time by using current and past time series data. However, there is a problem that a prediction error becomes extremely large at the peak values, that is, at the extreme values or in the vicinity thereof. Especially, the longer the prediction period is, the larger the prediction error becomes.

### BRIEF DESCRIPTION OF THE DRAWINGS

FIG. 1 is a block diagram of a prediction device according to an embodiment;

FIG. 2 is a chart illustrating two cases having difficulty in predicting a peak value;

FIG. 3 is a chart illustrating time series data of an objective variable and explanatory variables;

FIG. 4 is a chart illustrating an example of Kernel density estimation of the objective variable;

FIG. 5 is a chart illustrating an example where time series data of stationary state values are calculated from a time series data of the objective variable, and the values are sectioned at state change points;

FIG. 6 is a chart illustrating an example when generating model learning data;

FIG. 7 is a chart illustrating an example of model learning data;

FIG. 8 is a chart illustrating a first example of model learning;

FIG. 9 is a chart illustrating an example of processing following FIG. 8;

FIG. 10 is a chart illustrating an example of processing following FIG. 9;

FIG. 11 is an example when generating objective variable prediction data;

FIG. 12 is a chart illustrating an example of matching in objective variable prediction data and selecting a model according to the matching result;

FIG. 13 is a chart illustrating GUI that displays a model learning result and a prediction result;

FIG. 14 is a flowchart related to entire processing of the embodiment;

FIG. 15 is a chart illustrating an example of models determined for all sections in a modification example;

FIG. 16 is a chart illustrating an example of model selection after identifying a matching part in the modification example; and

FIG. 17 is a block diagram of an information processing system according to the embodiment.

### DETAILED DESCRIPTION

According to one embodiment, an information processing device includes: a divider configured to divide time series data of an objective variable into a plurality of first sections based on values of the objective variable; a model generator configured to generate, based on time series data of an explanatory variable and the time series data of the objective variable, a plurality of prediction models in which the explanatory variable and the objective variable are associated, for the plurality of first sections; a selector configured to select a first section from the plurality of first sections based on at least one of the time series data of the explanatory variable and the time series data of the objective variable; and a predictor configured to predict the value of the objective variable by using the prediction model generated for the selected first section.

Hereinafter, embodiments of the present invention will be described with reference to the accompanying drawings. Further, same reference signs are applied to the same structural elements in the drawings, and duplicated explanations are omitted as appropriate.

### First Embodiment

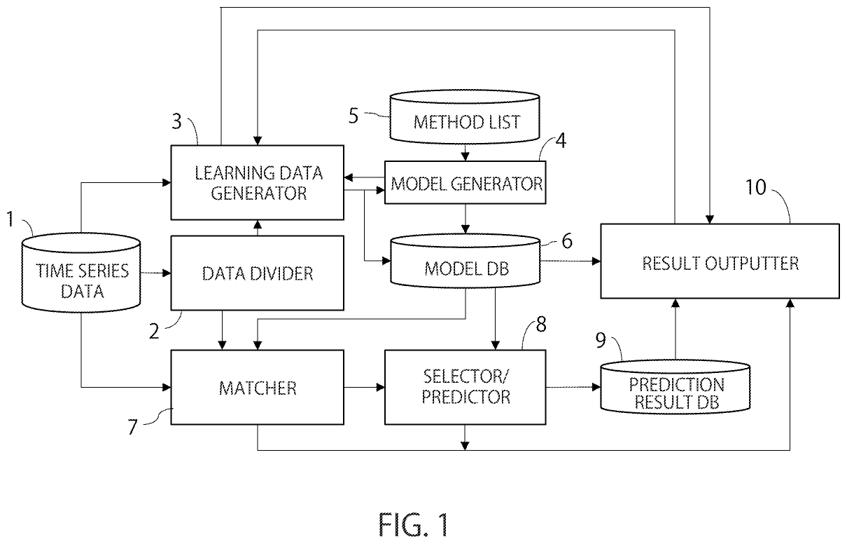

FIG. 1 is a block diagram of a prediction device 101 that is an information processing device according to a first embodiment. The prediction device 101 of FIG. 1 includes a time series data DB 1, a data divider 2 (divider), a learning data generator 3, a model generator 4, a method list 5, a model DB 6, a matcher 7, a selector/predictor 8 (selector, predictor), a prediction result DB 9, and a result outputter 10 (output circuit). At least one of the elements 2, 3, 4, 7, 8 and 10 are implemented by circuitry as one example.

The prediction device 101 of FIG. 1 predicts a future objective variable with high accuracy based on time series data including an explanatory variable and an objective variable. For example, prediction of a water level of a dam (prediction regarding a volume of stored water at a hydroelectric power plant), prediction of a wind speed, prediction of abnormal weather, prediction of a risk analysis, prediction of a stock price, and the like are performed. As a technical background of the embodiment, there is a problem that it is difficult to predict the objective variable, particularly peak values (extreme values). The embodiment is capable of performing prediction of the peak values of the objective variable with high accuracy.

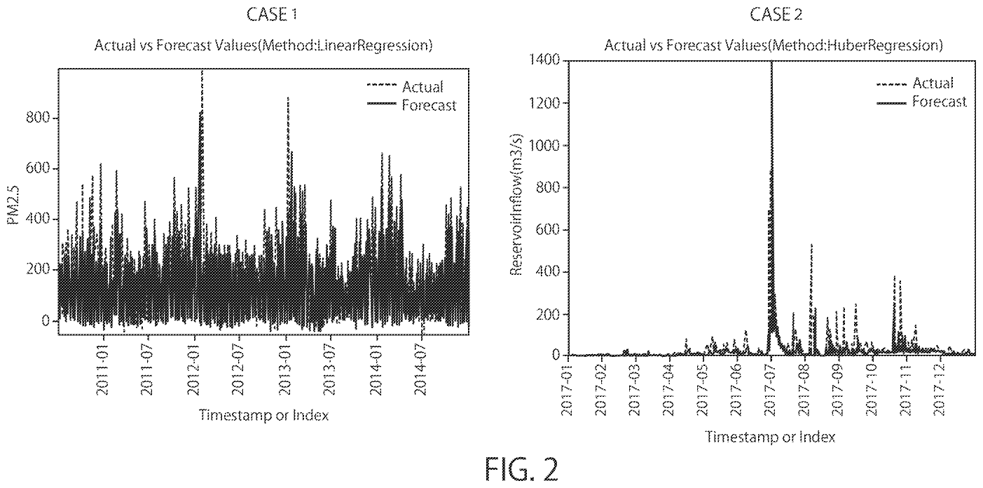

FIG. 2 illustrates two cases where prediction of the peak value is difficult. In prediction of case 1, the prediction value is lower than the actual value at most of the peaks. In prediction of case 2, the prediction value is larger than the actual value at large peaks. In other peaks that are small, the prediction value is lower than the actual value. The embodiment makes it possible to predict those values of the peaks (peak values) with high accuracy.

The time series data DB 1 holds past time series data of the objective variable. Further, the time series data DB 1 holds past and future time series data of the explanatory variable. The future time series data of the explanatory variable is the time series data of prediction values of the explanatory variable. Note that the future time series data of the explanatory variable may not necessarily need to be stored in the time series data DB 1. Among the time included in each piece of the past time series data, the time at which the objective variable is to be predicted from now on corresponds to the current time.

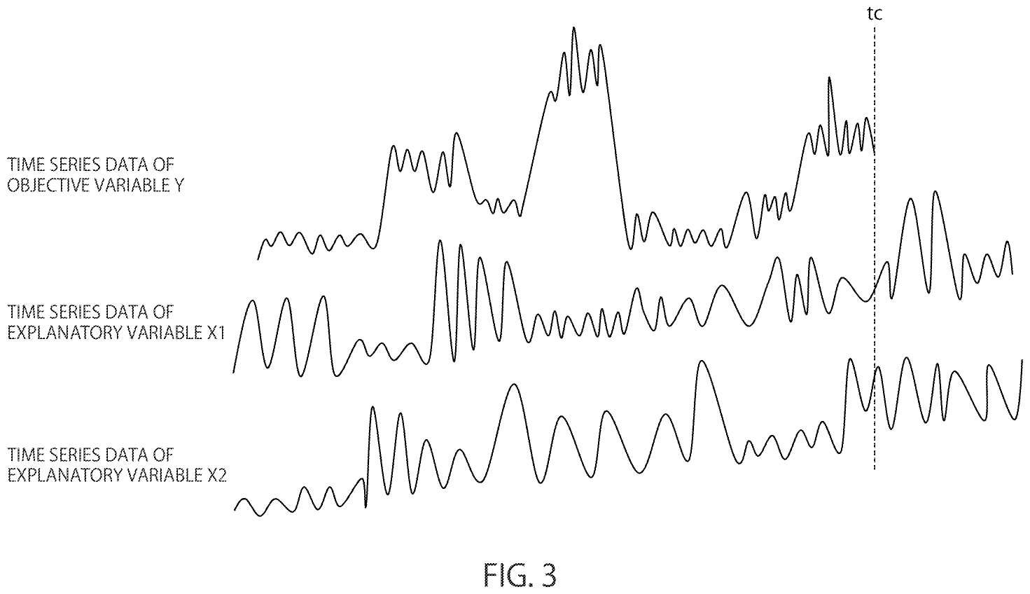

FIG. 3 is a chart illustrating the time series data of the objective variable and the time series data of the explanatory variables in a form of graph. The graph on the top is the past time series data of the objective variable. Assuming that the current time is “tc”, values of the objective variable before “tc” are included therein.

The second graph from the top is the time series data of the explanatory variable “X1”. More specifically, presented are the past time series data before “tc” and the future time series data after “tc”.

The graph at the bottom is the time series data of the explanatory variable “X2”. More specifically, plotted are the time series data before “tc” and the future time series data after “tc”.

There is no specific limit set for the method for acquiring the future time series data of the explanatory variables “X1” and “X2”. For example, if the explanatory variables “X1” and “X2” are variables related to the volume in regards to weather, prediction values of the future explanatory variables “X1” and “X2” may be acquired from an external weather server. Alternatively, future values of the explanatory variables “X1” and “X2” may be predicted from the past time series data by using a method such as a regression analysis or Vector AutoRegression (VAR).

The past time series data of the objective variable and the explanatory variables is used for generating model learning data for model learning. The future time series data of the explanatory variables is used as objective variable prediction data for predicting the future values of the objective variable.

The data divider 2 estimates a plurality of stationary state values (reference values) based on time series data of an objective variable. Then, the data divider 2 associates each of the stationary state values with the values of the objective variables, and determines the stationary state values of the objective variable. Thereby, the time series data of the stationary state values (time series data of the reference values) is generated from the time series data of the objective variable.

In order to estimate the stationary state values, it is possible to use a method using a distribution of the values of the objective variable, such as a clustering method or Kernel density estimation (KDE). Alternatively, as the stationary state values, it is possible to use a plurality of threshold values set in advance. Alternatively, it is also possible to determine the stationary state values based on the prediction error of a learned model. Some of specific examples thereof will be presented hereinafter.

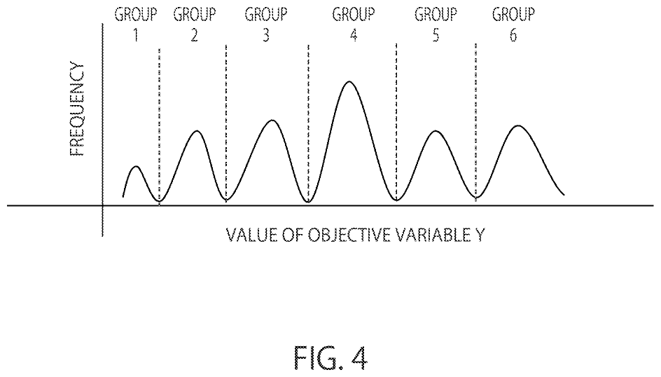

FIG. 4 illustrates an example of Kernel density estimation of the objective variable Y. Kernel density estimation estimates an unknown probability distribution of the objective variable. In the example of FIG. 4, presented is the probability distribution (frequency distribution) that is a result of performing Kernel density estimation on the time series data of the objective variable of FIG. 3. The horizontal axis is the values of the objective variable, and the vertical axis is the probability (frequency). This probability distribution is divided into a plurality of groups based on the peaks and valleys. In FIG. 4, the probability distribution is divided into six groups (groups 1 to 6). The representative value of each group is calculated, and the calculated representative values are defined as the stationary state values. Examples of the representative values may be a mean, a median, a maximum, a minimum, and a mode.

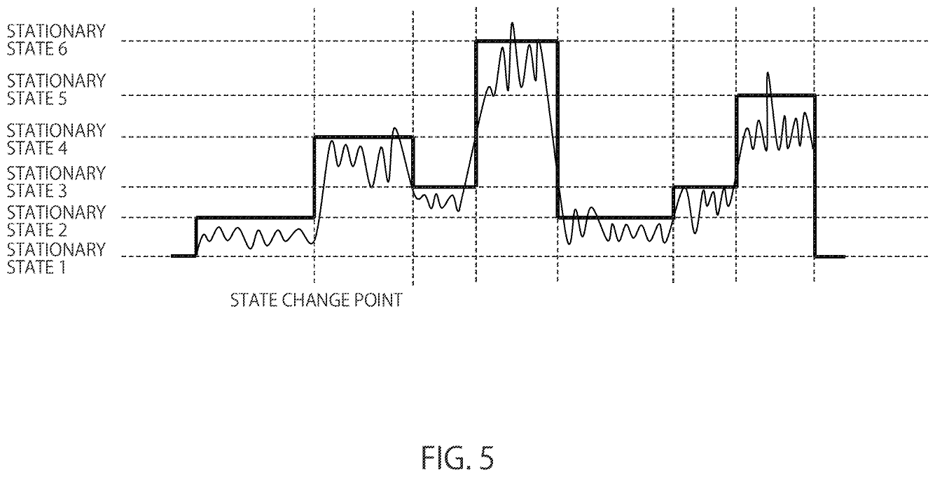

FIG. 5 illustrates an example where the time series data of the stationary state values is calculated from the time series data of the objective variable. The position where the stationary state value changes in the time axis direction corresponds to a state change point. Which stationary state value the value of the objective variable corresponds to is determined by an arbitrary method. For example, it may be defined to correspond to the closest stationary state value. Alternatively, it is also possible to acquire a graph of the stationary state values approximating the graph of the time series data of the objective variable, and use the data of the acquired graph as the time series data of the stationary state values. It is also possible to use other methods. In a case where the time series data of the objective variable frequently and greatly changes, the stationary state value may fluctuate at each point (at each time).

The data divider 2 divides the time series data of the objective variable into a plurality of sections (first sections) based on the values of the objective variable. As an example, the data divider 2 sections the objective variable at the state change points (that is, sections the time series data of the objective variable in the horizontal direction) to set a plurality of sections in the time direction. The data divider 2 sections the time series data of the objective variable according to the stationary state values (that is, sections the time series data of the objective variable in the vertical direction) to set the stationary state sections (sections between the reference values). The stationary state sections (sections between the reference values) can be used for evaluating the prediction error to be described later. By performing processing for considering that there is no error between the value of the objective variable and the prediction value in the same stationary state section (that the prediction is correct), model learning is efficiently performed. The sections (first sections) in the horizontal direction are used for selecting a model for each section to be described later. Further, it is possible to consider that the prediction value is correct even if there is a time lag in the peak predicted in model learning, when the section thereof in the horizontal direction is within the same section as will be described later. Thereby, prediction accuracy of the peak value can be improved further.

While the stationary state value is determined by using Kernel density estimation in FIG. 4, the data divider 2, as described above, may take each of a plurality of threshold values set in advance as the stationary state value. In that case, the plurality of threshold values may be set in advance in the time series data DB 1 as the plurality of stationary state values (reference values).

Further, the data divider 2 may determine the stationary state value by using the prediction error of a model. First, a model for predicting an objective variable from an explanatory variable is learned by using the time series data DB 1. The objective variable is predicted by using the learned model and the time series data DB 1. Model learning may be performed by using the same method as that of the model generator 4 to be described later or may be performed by a different method. When the prediction value of the objective variable is within a range set in advance for the value of the objective variable, it is determined that the prediction value is correct. The state value is calculated from the prediction value. The state value may be the prediction value itself, or may be a closest value among the plurality of threshold values defined in advance. Alternatively, the state value may be a mean of a plurality of prediction values determined as correct, or may put a plurality of prediction values into groups and take the representative value of each group as the state value. In next iteration, model learning is performed by using the data in the time series data DB 1 necessary for generating a prediction model of the objective variable whose prediction values are determined as incorrect in the previous iteration. Similarly, the objective variable is predicted by using the learned model and the necessary data. If the prediction value is within the range set in advance for the value of the objective variable, it is determined that the prediction value is correct. The state value is calculated from the prediction value. From all state values acquired at last, the stationary state values are calculated. All of the state values may be taken as each of the stationary state values. Alternatively, it is also possible to take the state values modified by integrating (taken a mean of) approximate state values thereof into one, for example, as the stationary state values.

The method list 5 holds information of one or more model learning methods used by the model generator 4. For example, held is the information such as initial parameter values, set parameter values, and architectures of the methods. As the model learning methods, there are prediction methods broadly used in the field of machine learning, such as linear regression, Huber regression, K-nearest neighbors regression (Kneighbors Regression), decision tree regression, a method based on deep learning such as LSTM (long/short term memory), statistical time series prediction model (autoregressive integrated moving average model, ARIMA and ARIMAX), an extreme value analysis (extreme value theory), and a neural network.

The learning data generator 3 generates model learning data used by the model generator 4 for model learning. As an example, first, model learning data is generated for all of the sections (all of the first sections) in the horizontal direction.

The model generator 4 generates, by using one or a plurality of model learning methods (in this example, a plurality of model learning methods), a plurality of prediction models (hereinafter, referred to as a model) in which the explanatory variable and the objective variable are associated by using the model learning data generated by the learning data generator 3. Generating a model is referred to as learning a model. A plurality of models generated herein are candidates of the models for each of the sections.

The learning data generator 3 performs evaluation of the learned models for each of the sections, and compares the number of sections whose prediction accuracy satisfies a condition (sections with high prediction accuracy) among the models. The model with the largest number of sections or the model in which the number of sections is equal to or more than a threshold value is selected. In the following explanations, a case of selecting the model with the largest number of sections is described. The selected model is determined for the section with a high prediction accuracy in the model.

The learning data generator 3 identifies the model learning data regarding the remaining sections other than the section where the model is determined (data necessary for generating the prediction model of the objective variable for the remaining sections).

For the identified model learning data, the model generator 4 generates the models by a plurality of model learning methods.

The learning data generator 3 performs evaluation of the leaned models for each of the remaining sections, and compares the number of sections with high prediction accuracy among the models. The model having the largest number of such sections is selected, and the selected model is determined for the section with high prediction accuracy. Among the remaining sections, the model learning data related to the sections (sections still remained) other than the sections where the model is determined is identified (data necessary for generating the prediction model of the objective variable for the sections still remained).

Thereinafter, the same processing is repeated until the model is determined for all of the sections.

Hereinafter, operations of the learning data generator 3 and the model generator 4 will be described in detail.

The model generator 4 learns models by a plurality of model learning methods based on the model learning data generated by the learning data generator 3. Further, the model generator 4 saves the parameter of the model selected from a plurality of learned models and the information of the sections determined for the model. Furthermore, the model learning data and the like used for learning the selected model may be saved in the model DB 6.

The model generator 4 performs a cross correlation analysis of the objective variable “Y” and each of the explanatory variables “X” based on the generated model learning data, and acquires a time lag of high cross correlation as cross correlation information. It is also possible to use a plurality of explanatory variables at different time as the variables for the model for the same explanatory variable “X” based on the cross correlation information. The model generator 4 saves the cross correlation information in the model DB 6.

When the value of the objective variable “Y” at time “t” (for example, current time) is “Y(t)” and the prediction value after time “Δt” is “Y(t+Δt)”, a following function (model) is defined. In the example, the past value “Y(t)” or the like of the objective variable is used for prediction of “Y(t+Δt)”. However, it is also possible to perform prediction of “Y(t+Δt)” only with the explanatory variables without using the past value “T(t)” or the like of the objective variable.

(t+Δt)=f(Y(t), . . . ,Y(t−l₀),

X₁(t+Δt−l₁−w), . . . ,X₁(min(t+Δt−1,t+Δt−l₁+w)),

X₂(t+Δt−l₂−w), . . . ,X₂(min(t+Δt−1,t+Δt−l₂+w)),

X₃(t+Δt−l₃−w), . . . ,X₃(min+Δt−1,t+Δt−l₃+w)),

X₄(t+Δt−l₄−w), . . . ,X₄(min(t+Δt−1,t+Δt−l₄+w)), . . . ) [Expression 1]

Note here that “Xi” is an explanatory variable, “Δt” is a prediction period, “Ii” is a time lag acquired by the cross correlation analysis, and “w” is a window width. Note that “Δt” and “w” are set in advance in the model generator 4, the model DB 6, or the like.

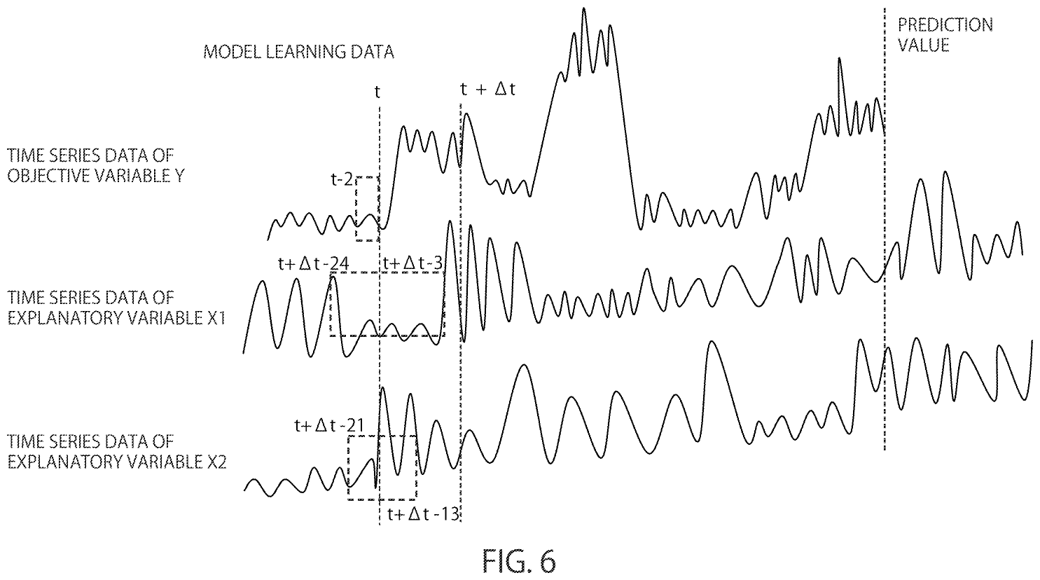

FIG. 6 illustrates an example of model learning data used for model learning of prediction after the time “Δt” for each time (timestamp) “t”. In the example, the prediction value “Y(t+Δt)” after “Δt” becomes a function of “{Y(t), Y(t−1), Y(t−2), X1(t+Δt−3), X1(t+Δt−4), . . . , X1(t+Δt−24), X2(t+Δt−13), X2(t+Δt−14), . . . , X2(t+Δt−21)}”.

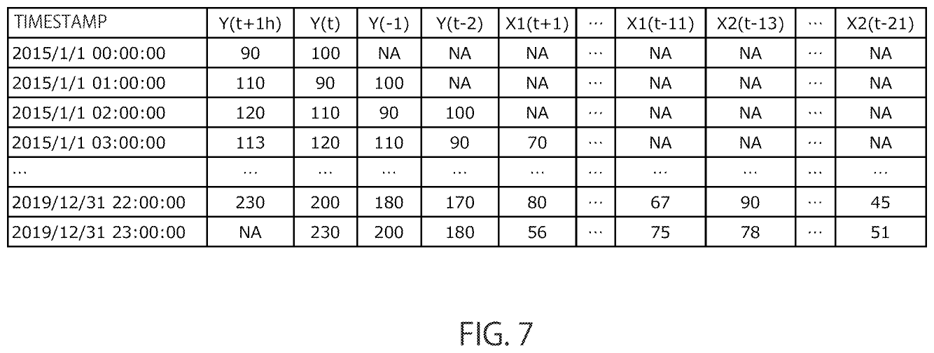

FIG. 7 is a chart presenting the model learning data for the time “t” in a table form. Note that “t+1 h” means 1 hour after the time “t”. The value of the objective variable at time “t” represents the value of the objective variable 1 hour before the time “t+1 h”.

In the function (model) described above, at least one explanatory variable at a first time is associated with the objective variable at a second time (“t+Δt” or “t+1 h”). At least one explanatory variable at the first time in the example of FIG. 6 or FIG. 7 is “X1” at “t+Δt−3”, “t+Δt−4”, . . . , or X2 at “t+Δt−13”, “t+Δt−14”, . . . , or both of those.

In the function (model) described above, further, at least one explanatory variable at the first time and the objective variable at a third time that is before the second time are associated with the objective variable at the second time (that is, past value “Y(t)” or the like of the objective variable is used for prediction of “Y(t+Δt)”).

For each of a plurality of models learned by the model generator 4, the learning data generator 3 calculates the prediction values by using the model learning data used for learning the models. Evaluation of the models is performed based on the prediction values. The prediction value is determined to be correct or incorrect based on whether or not the prediction value satisfies a first condition.

For example, when the prediction value is in a stationary state section (section between the reference values) where the actual value of the objective variable belongs, it is determined as correct.

Alternatively, it is also possible to perform evaluation for each of the prediction values based on whether or not it is within the range set in advance for the actual value. The range set in advance may be a range of “μ−3σ to μ+3σ” or a range of “actual value×1.1”, for example. Note that “μ” is a mean, and “σ” is a standard deviation. When the prediction value is included within the range, the prediction value is determined as correct. In particular, in a case where the time series data of the objective variable frequently and greatly changes, it is considered to use a latter method.

Further, even when the prediction value does not satisfy the first condition but the object variable satisfying the first condition exists within a specific window width (time width), the prediction value may be determined as correct. This makes it possible to allow a case where the peak occurs with a time lag within the window width. The peak may be detected from the time series data by using a peak detection technique for detecting the peak, or a condition of the peak may be given in advance and the value satisfying such a condition may be taken as the peak.

The learning data generator 3 evaluates the prediction accuracy of the section based on the number of correct values within the points (prediction values) that are in the section. For example, in a case where the correct rate within a given section is 70% or more, it is determined to satisfy a selection criterion (high prediction accuracy). In a case where the correct rate is less than 70%, it is determined not to satisfy the selection criterion (low prediction accuracy).

The learning data generator 3 can also use an evaluation scale broadly used in the field of prediction instead of the number of matched correct values. As the evaluation scale between each of the sections, it is possible to use root mean square error (RMSE), coefficient of determination (R²), mean absolute error (MAE), and mean absolute percentage error (MAPE).

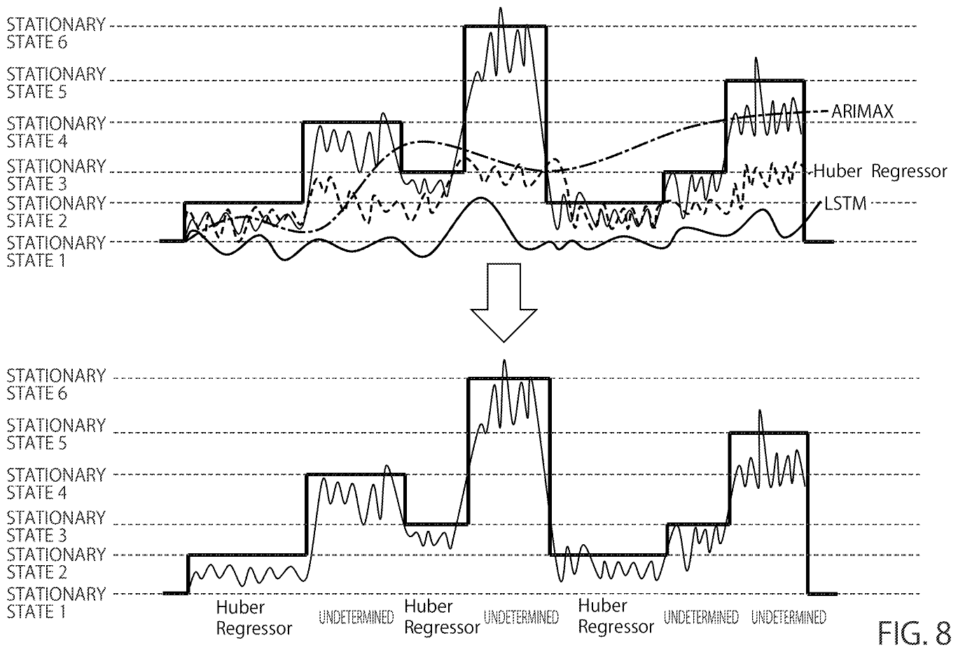

FIG. 8 illustrates a specific example of model learning and generation of model learning data. First, as illustrated on the upper side of FIG. 8, the model generator 4 performs model learning by using three methods (ARIMAX, LSTM, Huber regressor) by using the whole data of the model learning data. The learning data generator 3 evaluates each section for each of the models based on the prediction result acquired by using the leaned model. Huber regressor is the best method, since it has the largest number of sections predicted with high accuracy. The model learned by Huber regressor is defined as a model M(1). The sections with high prediction accuracy are the sections 1, 3, and 5, so that the model M(1) is determined for the sections 1, 3, and 5 as illustrated in the lower side of FIG. 8. The model generator 4 or the learning data generator 3 saves the model parameter of Huber regressor that is the model M(1) and the information for identifying the sections 1, 3, and 5 in the model DB 6. An example of the information for identifying the sections 1, 3, and 5 is the start/end time of the sections 1, 3, and 5. The model learning data used for generating the model M(1) may also be saved.

The learning data generator 3 eliminates the data regarding the sections 1, 3, and 5 (data necessary only for generating the model for predicting the objective variable in the sections 1, 3, and 5) from the model learning data. That is, only the model learning data necessary for generating the models for predicting the objective variable in the sections 2, 4, 6, and 7 is identified.

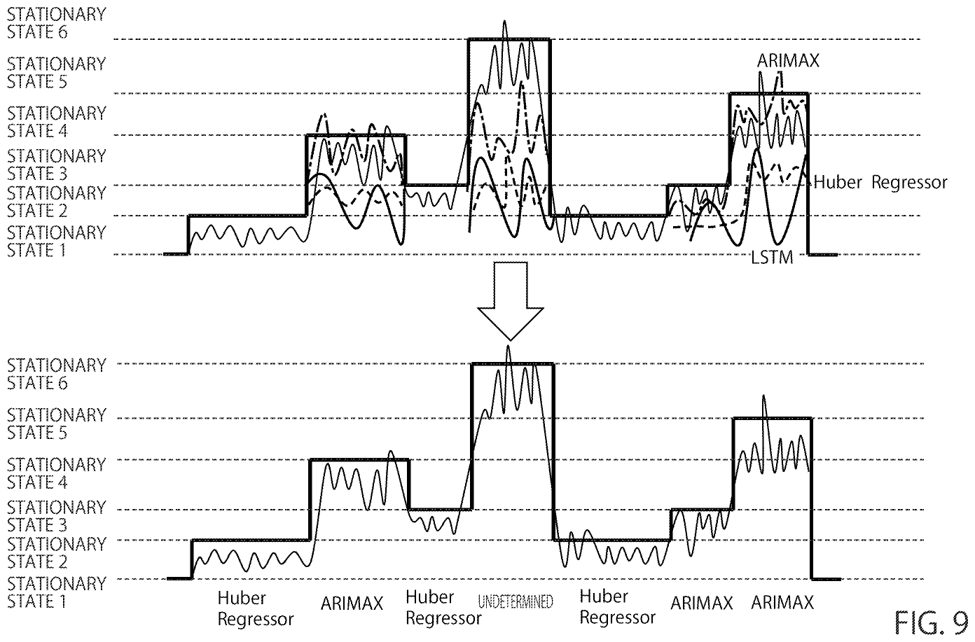

FIG. 9 is a chart for describing the operations following FIG. 8. The model generator 4 learns the models by applying the three methods (ARIMAX, LSTM, Huber regressor) to the model learning data regarding the sections 2, 4, 6, and 7. Thereafter, the learning data generator 3 evaluates the sections 2, 4, 6, and 7 based on the prediction values for each of the models as in the previous time. This time, ARIMAX is the best method, since it has the largest number of sections predicted with high accuracy. The model learned by ARIMAX is defined as a model M(2). The sections with high prediction accuracy are the sections 2, 6, and 7, so that the model M(2) is determined for the sections 2, 6, and 7 as illustrated in the lower side of FIG. 9. The model generator 4 or the learning data generator 3 saves the model parameter of ARIMAX that is the model M(2) and the information for identifying the sections 2, 6, and 7 in the model DB 6. An example of the information for identifying the sections 2, 6, and 7 is the start/end time of the sections 2, 6, and 7. The model learning data used for generating the model M(2) may also be saved.

The learning data generator 3 eliminates the data regarding the sections 2, 6, and 7 (data necessary only for generating the model for predicting the objective variable in the sections 2, 6, and 7) from the model learning data. That is, only the model learning data necessary for generating the model for predicting the objective variable in the section 4 is identified.

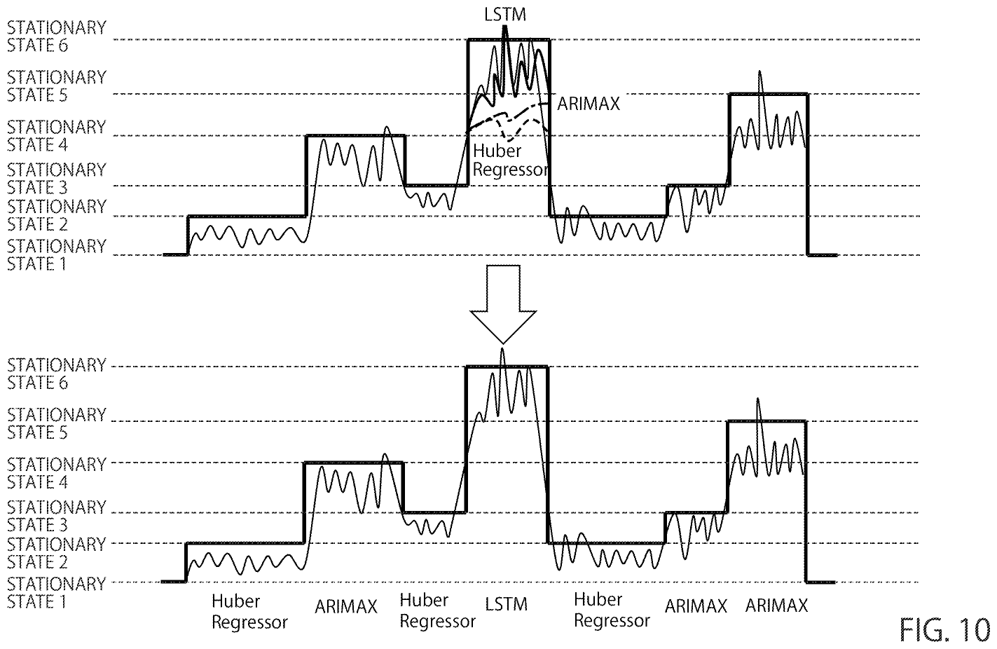

FIG. 10 is a chart for describing the operations following FIG. 9. For the section 4, the models are learned in the same manner by using the three methods. The section 4 is evaluated for each of the models based on the prediction value. This time, LSTM is able to perform prediction with the highest accuracy, so that the model learned by LSTM is defined as a model M(3). The model M(3) is determined for the section 4. The model generator 4 or the learning data generator 3 saves the model parameter of LSTM that is the model M(3) and the information for identifying the section 4 in the model DB 6. An example of the information for identifying the section 4 is the start/end timestamps of the section 4. The model learning data used for generating the model M(3) may also be saved.

Since the models are determined for all of the sections, the processing of the learning data generator 3 is ended.

The matcher 7 generates objective variable prediction data by using the time series data DB 1. As in the case of generating the model learning data, the objective variable prediction data is generated for predicting the objective variable at prediction time by using cross correlation information, for example.

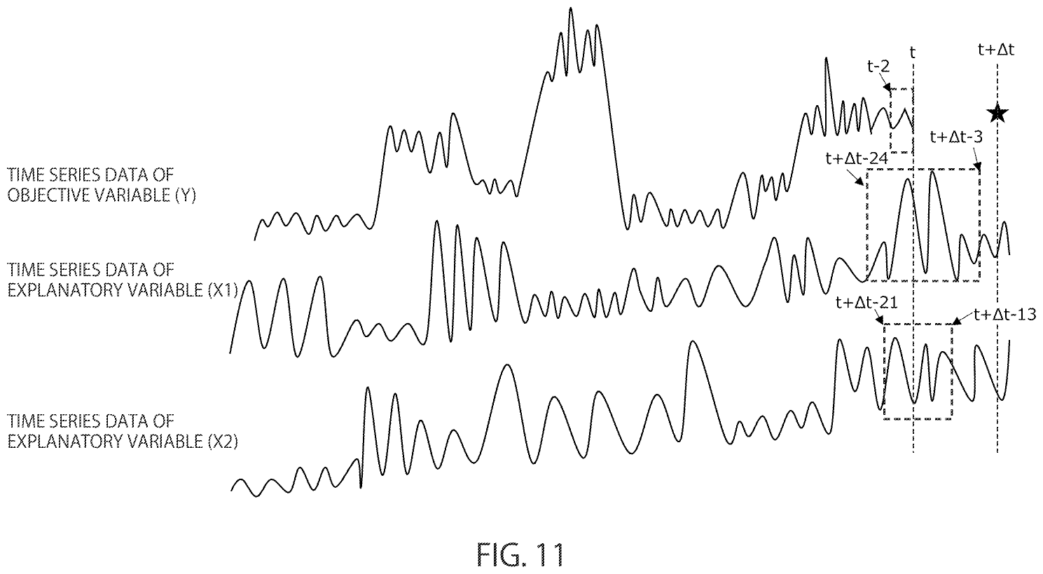

FIG. 11 illustrates an example for generating the objective prediction data. As an example, when the prediction time (prediction timestamp) is “t+Δt”, the objective variable prediction data becomes “{Y(t), Y(t−1), Y(t−2), X1(t+Δt−3), X1(t+Δt−4), . . . , X1(t+Δt−24), X2(t+Δt−13), X2(t+Δt−14), . . . , X2(t+Δt−21)}”.

Note that “X1(t+Δt−3), X1(t+Δt−4), . . . , X1(t+Δt−24), X2(t+Δt−13), X2(t+Δt−14), . . . , X2(t+Δt−21)” corresponds to the prediction data including the explanatory variable at least at one time. The objective variable prediction data of FIG. 11 includes the prediction data of the explanatory variables and the objective variables “Y(t)”, “Y(t−1)”, and “Y(t−2)”. The time period from a certain time (for example, “t+Δt−3”) of the explanatory variable to a certain time of the objective variable (for example, “t”) corresponds to a second time period, for example. Depending on the form of the model function, it is also possible to employ a configuration in which the objective variable prediction data dose not include the objective variable.

The matcher 7 identifies a part (matching part) that matches the objective variable prediction data from the model learning data (see FIG. 7) or the time series data (see FIG. 3). That is, in regards to the prediction data including the explanatory variable at the time (for example, “t+Δt−3” to “t+Δt−24”) and the explanatory variable at the time (“t+Δt−13” to “t+Δt−21”) and the values of the objective variable at the time (for example, “t”, “t−1”, and “t−2”) as a set, at least one matching part is specified in the time series data of the explanatory variable and the time series data of the objective variable as a set. The time (for example, “t”, “t−1”, and “t−2”) of the objective variable corresponds to the time before or after the second time period from the time of the matching part (for example, the time of a first position of the explanatory variable). In a case where the objective variable prediction data does not include the objective variable, at least one part that matches the time series data of the explanatory variable may be identified.

Specifically, the matcher 7 calculates the distance (hereinafter, referred to as similarity) using a plurality of time series waveforms (a time series waveform of the objective variable, a time series waveform of the explanatory variable “X1”, and a time series waveform of the explanatory variable “X2”), and searches for a matching part based on the similarity. As the similarity, Euclidean distance can be used. It is also possible to use a time series distance calculation method such as dynamic time warping (DTW) instead of the Euclidean distance.

In a case where the model learning data is “Y(t1), Y(t1−1), Y(t1−2), X1(t1+Δt−3), X1(t1+Δt−4), . . . , X1(t1+Δt−24), X2(t1+Δt−13), X2(t1+Δt−14), . . . , X2(t1+Δt−21)” and the objective variable prediction data is “Y(t), Y(t−1), Y(t−2), X1(t+Δt−3), X1(t+Δt−4), . . . , X1(t+Δt−24), X2(t+Δt−13), X2(t+Δt−14), . . . , X2(t+Δt−21)”, similarity S as follows can be calculated by the Euclidean distance.

$$S = \sqrt{{\sum }_{k = 0}^{k = 2} {( \begin{matrix}Y ( {t}_{1} - k ) - \\ Y ( t - k )\end{matrix} )}^{2}} + \sqrt{{\sum }_{k = 3}^{k = 24} {( \begin{matrix}{X}_{1} ( {t}_{1} + Δ t - k ) - \\ {X}_{1} ( t + Δ t - k )\end{matrix} )}^{2}} + \sqrt{{\sum }_{k = 13}^{k = 21} {( \begin{matrix}{X}_{2} ( {t}_{1} + Δ t - k ) - \\ {X}_{2} ( t + Δ t - k )\end{matrix} )}^{2}} \qquad [ Expression 2 ]$$

Searching is performed by reducing “t1” by 1 to search for the matching part. As an example, it is defined as “t1=t−Δt” in the first-time processing, defined as “t1=t−Δt−1” in the second-time processing, defined as “t1=t−Δt−2” in the third-time processing, and defined in the same manner thereinafter to calculate the similarity S.

The matcher 7 identifies the model learning data with which the similarity S becomes optimal (the value of the similarity is the smallest) and the time (timestamp) “t1+Δt”.

The identified time “t1+Δt” is the time after the first time period from the time of the matching part. For example, assuming that the time of the first position (for example, the time “t1+Δt−3” of the explanatory variable “X1”) among the time of the explanatory variable is the time of the matching part, it is the time “t1+Δt” that is after 3 hours from that time. Alternatively, assuming that the time “t1” of the objective variable “Y” is the time of the matching part, it is “t1+Δt” that is after “Δt” from that time.

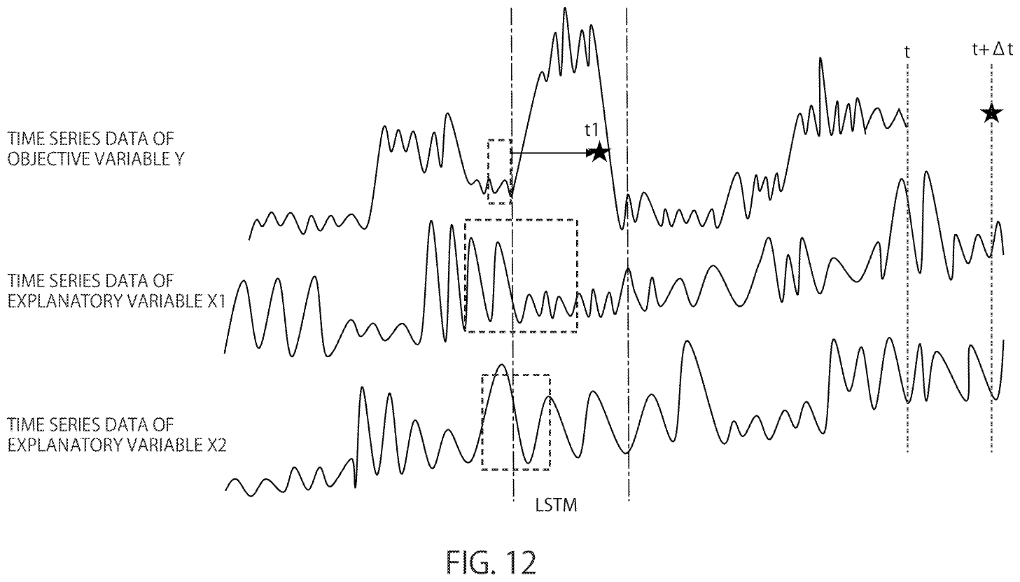

FIG. 12 illustrates the matching result. The best matched time series waveform (the model learning data with which the similarity S becomes the optimal) is presented with a frame surrounded by a broken line. Further, the time “t1+Δt” is pointed. The model corresponding to the section including the time “t1+Δt” is LSTM.

The selector/predictor 8 selects the model corresponding to the section where the time “t1+Δt” belongs. The data of the selected model is acquired from the model DB 6. The prediction value is calculated by inputting the objective variable prediction data into the acquired model.

The matcher 7 may identify not only the matching part where the similarity S is the optimal (the similarity S is the smallest) but also a plurality of matching parts where the similarity is suboptimal and the respective time “t1+Δt” of those. Suboptimal means that the value of the similarity S is equal to or less than a threshold value or included within a specific range, for example. The matcher 7 predicts the values by using a plurality of models where the respective time “t1+Δt” of a plurality of matching parts belong. A mean, a maximum, a minimum, or the like of a plurality of prediction values is calculated to be defined as a comprehensive prediction value. When the prediction period is long (when “Δt” is large), there is a higher possibility that the prediction value of one model is greatly deviated from the actual value. Therefore, by extracting a plurality of matching parts and predicting the values by using a plurality of models corresponding respectively, the accuracy may be improved so that the reliability is increased.

The prediction result DB 9 stores the prediction value calculated by the selector/predictor 8 and the prediction time (“t+Δt”). The prediction result DB 9 may further store the matching part identified by the matcher 7, the identified model learning data, and the time “t1” of the matching part.

The result outputter 10 includes a GUI (Graphic User Interface) function that outputs the model learning result and the prediction result. By using the GUI, the user (an operator, an expert, or the like) of the device can check the model learning result and the prediction result.

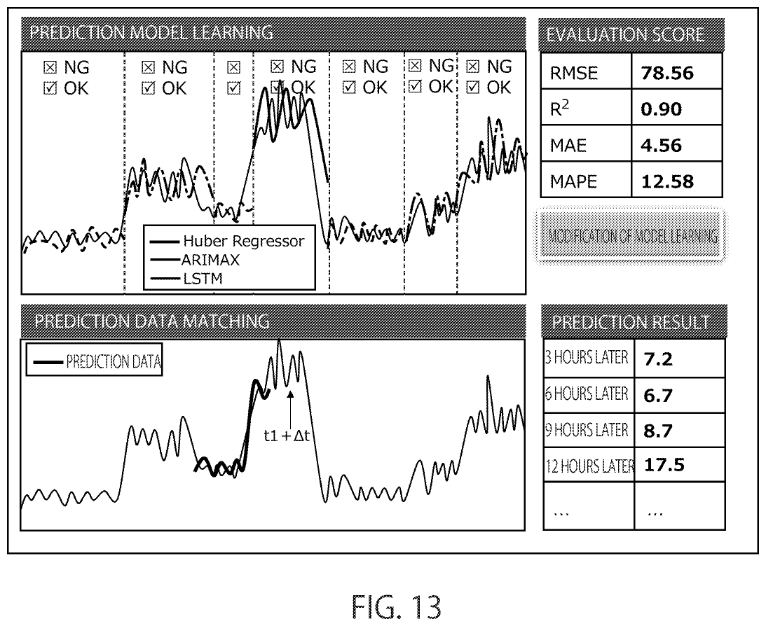

FIG. 13 illustrates a display example of the GUI. The GUI has display sections of a plurality of items. Provided are “Prediction Model Learning”, “Prediction Data Matching”, “Evaluation Score”, “Prediction Result”, and “Modification of Model Learning”.

In “Prediction Model Learning”, the time series data of the objective variable in each of the sections and the prediction values of the models selected for each of the sections are displayed. The user can look at the visualized result, and determine whether the accuracy of the prediction values between each of the sections are good or not. When “NG” is selected at least in one of the sections, through clicking a button of “Modification of Model Learning” by the user, the model generator 4 performs relearning of the model only in that section and selects the model of the highest accuracy.

In “Evaluation Score”, the calculated evaluation scale is displayed when the evaluation scale is calculated at the time of model learning. As the evaluation scale, there are root mean square error (RMSE), coefficient of determination (R²), mean absolute error (MAE), mean absolute percentage error (MAPE), and the like.

In “Prediction Result”, the prediction value of the objective variable after a specific time (after “Δt”) is displayed. In the example of the chart, prediction values after a plurality of specific time periods are displayed.

In “Prediction Data Matching”, the optimal matching part identified by the matcher 7, the objective variable prediction data where there is matching, and the time “t1” of the matching part are displayed. In the example of the chart, displayed are the objective variable prediction data used when performing prediction of the time after a certain time (for example, 3 hours later), the matching part of the objective variable prediction data, and the time “t1” of the matching part.

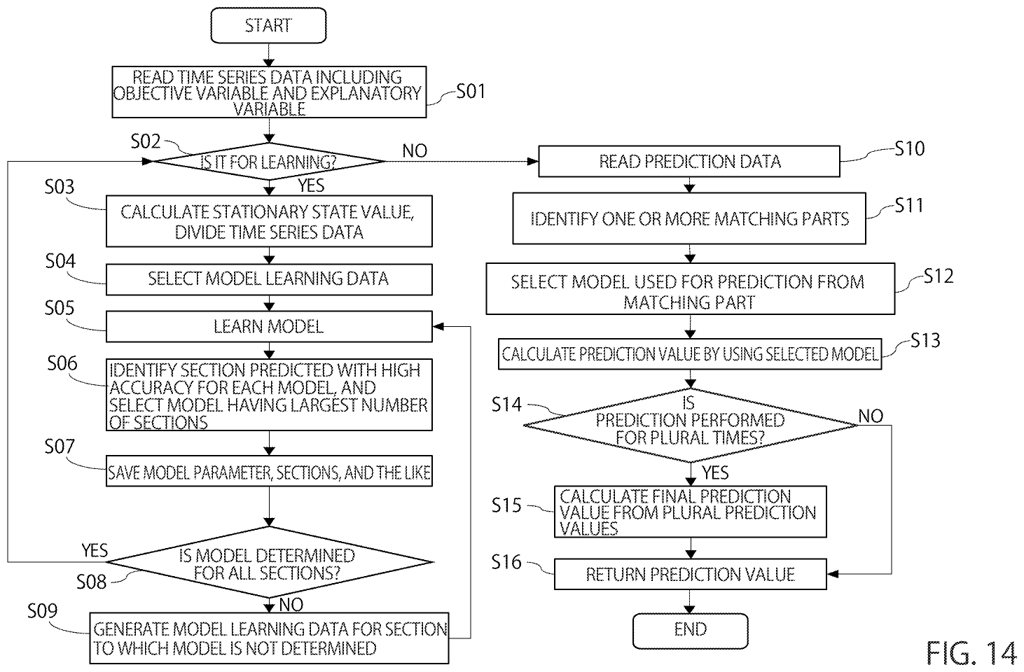

FIG. 14 illustrates a flowchart related to the whole processing of the embodiment. First, the data divider 2 reads the time series data including the objective variable and the explanatory variable from the time series data DB 1 (step S01).

Next, the data divider 2 determines whether to perform a learning phase for leaning models or to perform a prediction phase by using learning/prediction flags set in advance in the time series data DB 1 (step S02). When performing the learning phase (YES in step S02), the data divider 2 calculates stationary state values by using the time series data of the objective variable, and identifies the stationary state values for the objective variable at each time (step S03). The time series data of the objective variable may be approximated to a graph of the stationary state values. Furthermore, based on the state change points of the stationary states, the time series data of the objective variable is divided into a plurality of sections (divided in the horizontal direction (same step S03).

Next, the learning data generator 3 generates the model learning data. At first, the model learning data is generated for all of the time (for all of the sections) (step S04).

Next, the model generator 4 learns a plurality of models by using the model learning data generated by the learning data generator 3 and using one or more model learning methods (in the description, a plurality of model learning methods are assumed) (step S05).

The learning data generator 3 performs prediction for each time (point) in a plurality of sections by using each of the models learned by the model generator 4, and determines whether or not prediction is correct (step S06). As an example, in a case where the prediction value belongs to a section same as the actual value between the stationary state values, it is determined as correct. The section where the correct rate is equal to or larger than a threshold value is identified, and the number of identified sections is calculated for each of the models (same step S06). The model with the largest number of sections is selected, and the section where the correct rate is equal to or more than the threshold value is determined for or associated with the selected model (same step S06). The parameter of the selected model, information of the section to which the selected model corresponds, the model learning data used for learning the selected model, and the like are saved in the model DB 6 (step S07).

When the model is determined for all of the sections (YES), the processing is returned to step S02. Further, the learning data generator 3 may give an instruction to the result outputter 10 to visualize the model learning result. When there is a section where the model is not determined yet (NO), the model learning data necessary for generating the model only for that section is generated, and the processing is returned to step S05.

When determined in step S02 to perform the prediction phase (NO in step S02), the matcher 7 reads the objective variable prediction data from the time series data DB 1 (step S10). The matcher 7 identifies one or more matching parts from the model learning data or the time series data (step S11).

The selector/predictor 8 selects the model corresponding to the section where the time “t1” of the matching part (the time of the objective variable predicted from the matching part) is included (step S12). The selector/predictor 8 calculates the prediction value by using the selected model (step S13).

The selector/predictor 8 determines whether or not there are a plurality of identified matching parts, that is, whether or not to perform prediction for a plurality of times (for example, whether or not to use a plurality of models) (step S14). When there are a plurality of matching parts, there is a possibility that all of the models corresponding to those matching parts are the same. When the prediction is not performed for a plurality of times (NO in step S14), the selector/predictor 8 returns the prediction value (step S16). When the prediction is performed for a plurality of times (YES in step S14), the selector/predictor 8 calculates the final prediction value by using a plurality of prediction values (step S15), and returns the prediction value (step S16). After step S16, the selector/predictor 8 may give an instruction to the result outputter 10 to visualize the matching part, the prediction result, and the like.

As described above, according to the embodiment, the time series data of the objective variable is divided into a plurality of sections, and a model (prediction model) is generated for each of the sections. In the time series data of the objective variable and the explanatory variable, the part matching the objective variable prediction data is identified, and the objective variable is predicted by using the model corresponding to the section where the time after a prediction period from the time of the identified part is included. Thereby, the objective variable can be predicted with high accuracy. For example, even in a case where the objective variable after the prediction period corresponds to a peak, the objective variable can be predicted with high accuracy. By allowing a time lag of the peak within a window width in model learning, it is possible to detect the peak within an allowable range (window width) even if there is a time lag in the predicted peak. Therefore, the embodiment is effective for detecting the peak.

### Modification Example

In the embodiment described above, a model is generated for each of the sections divided horizontally. As a modification example, a model may be generated for each of the sections of the stationary state value divided vertically (each of the sections of the reference value). In that case, it is not necessary to divide the data horizontally. The same processing may be performed while considering the sections of the stationary state values as the sections (first sections) of the embodiment.

That is, for each of the sections of the stationary state value, a plurality of models are generated as the candidates in the same manner as that of the embodiment described above. For each of the models, the correct rate of the sections of the stationary state value is calculated, and the model with the largest number of sections where the correct rate is equal to or more than the threshold value is selected. The selected model is determined for the section where the correct rate is equal to or more than the threshold value. For the sections where the model is not determined, a plurality of models are regenerated as the candidates, and a model is selected and the section to which the selected model is applied is determined. When the model is determined for all of the sections, the processing for generating the models is ended.

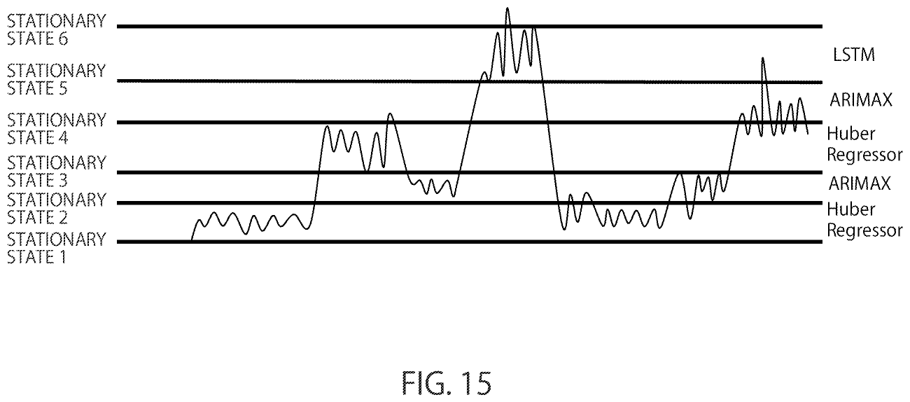

FIG. 15 illustrates examples of the models determined for all of the sections. For example, a model of ARIMAX is selected for the section between a stationary state value 4 and a stationary state value 5.

Various kinds of alternative methods that are described to be usable in the embodiment above are applicable also in the modification example. For example, instead of making determination by using the correct rate, it is possible to use root mean square error, coefficient of determination, mean absolute error, or mean absolute percentage error as the evaluation scale for each of the sections.

In regards to matching using the objective variable prediction data, the processing performed after identifying the matching part is different. In the embodiment described above, after identifying the matching part, the section where the time “t1+Δt” that is after the prediction period from the time of the matching part is included is identified. However, in the modification example, the section where the value of the objective variable at the time “t1+Δt” is included is selected. A model corresponding to that section is selected. The processing to be performed after selecting the model is the same as that of the embodiment described above.

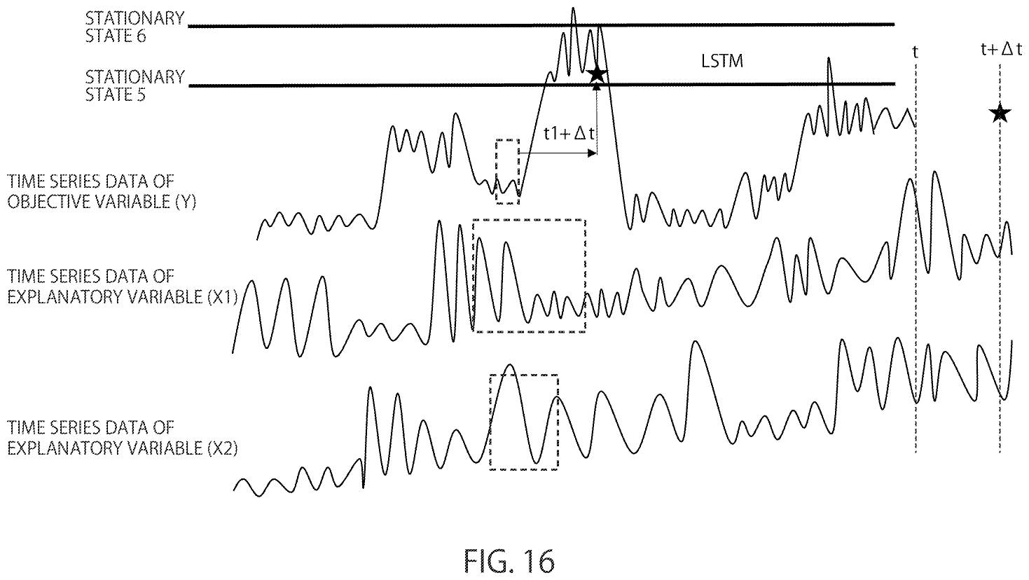

FIG. 16 illustrates an example of selecting a model after identifying a matching part. The objective variable “Y(t1+Δt)” after the prediction period from the time of the matching part is included in the section between the stationary state value 5 and a stationary state value 6. A model of LSTM corresponding to that section is selected.

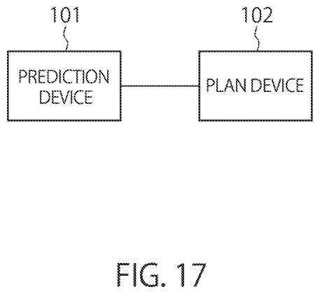

FIG. 17 illustrates an information processing system according to the embodiment. The information processing system of FIG. 17 includes an information processing device (the prediction device) 101 and a plan device (planner) 102 according to the embodiment. The prediction device 101 and the plan device 102 are communicable by wire or wirelessly. The plan device 102 may also be mounted into the prediction device 101.

In the example, the prediction device 101 predicts the objective variable related to a volume of stored water at a hydroelectric power plant. For example, the objective variable is a volume of stored water in a dam, a water level thereof, a water level of a river, or the like. The explanatory variable is the amount regarding weather (weather, precipitation, temperature, and the like). The prediction device 101 provides the predicted prediction value of the objective variable to the plan device 102. The plan device 102 generates a power generation plan based on the future prediction value of the objective value. For example, a power generation plan for allowing the water level of a dam to fall within a specific range is generated. In a case where a water level becomes lowered because the future precipitation is insufficient or the like and it is expected that a desired power generation amount cannot be acquired, it is possible to perform a control such as requesting the consumers to save the power through a demand/supply control or the like by demand response. A method of power generation plan is not limited to a specific method, and any methods may be used as long as the output result of the prediction device 101 is used. For example, when it is expected to face shortage of electric power generation, pumped-storage power generation or the like may additionally be executed. It is also possible to inform the power generation amount that may become short, for example, to another power generation plant such as a nuclear power plant.

At least a part of structural components of the prediction device according the embodiment described above may be put into a chip. Further, inside SoC (System on Chip) such as an edge device, for example, at least a part of structural components of the prediction device according the embodiment may be mounted. In that case, the time series data DB 1 and the prediction result DB 9 may be provided outside the SoC so as to be able to make an access via a prescribed interface device. At least a part of the prediction device described in the embodiment above may be configured with hardware or with software. In a case of configuring it with software, a program implementing at least a part of the functions of the prediction device may be stored in a recording medium such as a flexible disk or a CD-ROM, and may be executed by being loaded on a computer such as a processor. The recording medium is not limited to a removable medium such as a magnetic disk or an optical disk but may also be a fixed recording medium such as a hard disk device or a memory.

1. An information processing device, comprising:
a divider configured to divide time series data of an objective variable into a plurality of first sections based on values of the objective variable;
a model generator configured to generate, based on time series data of an explanatory variable and the time series data of the objective variable, a plurality of prediction models in which the explanatory variable and the objective variable are associated, for the plurality of first sections;
a selector configured to select a first section from the plurality of first sections based on at least one of
the time series data of the explanatory variable and
the time series data of the objective variable; and
a predictor configured to predict the value of the objective variable by using the prediction model generated for the selected first section.

2. The information processing device according to claim 1, wherein the divider divides the time series data of the objective variable in a time direction to generate the plurality of first sections.

3. The information processing device according to claim 2, wherein:
in the prediction model, the explanatory variable at a first time is associated with the objective variable at a second time that is later than the first time;
a time period from the first time to the second time is a first time period;
the information processing device comprises a matcher configured to identify at least one part that matches prediction data in the time series data of the explanatory variable, the prediction data including a prediction value of the explanatory variable; and
the selector selects the first section where time after the first time period from the matching part is included.

4. The information processing device according to claim 2, wherein:
in the prediction model, the explanatory variable at a first time and the objective variable at a third time are associated with the objective variable at a second time later than the third time;
a time period from the first time to the second time is a first time period;
the third time is time before or after a second time period from the first time;
the information processing device comprises a matcher configured to identify at least one part where a set of prediction data and the value of the objective variable at time before or after the second time period from the prediction data matches a set of the time series data of the explanatory variable and the time series data of the objective variable, the prediction data including a prediction value of the explanatory variable; and
the selector selects the first section where time after the first time period from time of the matching part is included.

5. The information processing device according to claim 2, wherein the divider associates the value of the objective variable included in the time series data of the objective variable with any of a plurality of reference values to generate time series data of the reference values, and divides the time series data of the objective variable at a time where the reference values change to generate the plurality of first sections.

6. The information processing device according to claim 1, wherein the divider divides the time series data according to ranges of the values of the objective variable to generate the plurality of first sections.

7. The information processing device according to claim 6, wherein:
in the prediction model, the explanatory variable at a first time is associated with the objective variable at a second time that is later than the first time;
a time period from the first time to the second time is a first time period;
the information processing device comprises a matcher configured to identify at least one part that matches prediction data in the time series data of the explanatory variable, the prediction data including a prediction value of the explanatory variable; and
the selector selects the first section where the value of the objective variable at time after the first time period from the matching part is included.

8. The information processing device according to claim 6, wherein:
in the prediction model, the explanatory variable at a first time and the objective variable at a third time are associated with the objective variable at a second time later than the third time;
a time period from the first time to the second time is a first time period;
the third time is time before or after a second time period from the first time;
the information processing device comprises a matcher configured to identify at least one part where a set of the prediction data and the value of the objective variable at time before or after the second time period from the prediction data matches a set of the time series data of the explanatory variable and the time series data of the objective variable, the prediction data including a prediction value of the explanatory variable; and
the selector selects the first section where time after the first time period from time of the matching part is included.

9. The information processing device according to claim 6, wherein:
the divider divides the time series data of the objective variable into the plurality of first sections according to a plurality of reference values; and
the plurality of first sections are a plurality of sections between the plurality of reference values.

10. The information processing device according to claim 5, wherein the divider determines the plurality of reference values based on a distribution of the values of the objective variable included in the time series data of the objective variable.

11. The information processing device according to claim 5, wherein the plurality of reference values are a plurality of threshold values set in advance.

12. The information processing device according to claim 5, wherein the model generator:
generates a plurality of candidates of the prediction model for the first section;
calculates prediction values of the objective variable by using the plurality of candidates; and
determines that the prediction value is correct when the prediction value is included in the section between the reference values same as the objective variable, and selects the prediction model from the plurality of candidates based on a number of correct prediction values.

13. The information processing device according to claim 5, wherein the model generator:
generates a plurality of candidates of the prediction model for the first section;
calculates prediction values of the objective variable by using the plurality of candidates and the time series data of the explanatory variable;
determines whether the prediction value is correct based on whether the prediction value satisfies a first condition, and selects a candidate from the plurality of candidates based on a number of correct prediction values; and
in a case where the first condition is not satisfied and there is a value of the objective variable satisfying the first condition for the prediction value existing within a window width from a time of the prediction value, determines that the prediction value is correct.

14. The information processing device according to claim 1, wherein
the selector selects the first sections; and
the predictor predicts the objective variable by using the plurality of prediction models generated for the plurality of first sections.

15. The information processing device according to claim 1, wherein the model generator generates the prediction models based on deep learning, a statistical method, or a regression method.

16. The information processing device according to claim 1, comprising an output circuit configured to output information regarding the plurality of first sections, the prediction model corresponding to the selected first section, and a prediction value of the objective variable acquired by the prediction model.

17. An information processing method, comprising:
dividing time series data of an objective variable into a plurality of first sections based on values of the objective variable;
generating, based on time series data of an explanatory variable and the time series data of the objective variable, a plurality of prediction models in which the explanatory variable and the objective variable are associated, for the plurality of first sections;
selecting a first section from the plurality of first sections based on at least one of
the time series data of the explanatory variable and
the time series data of the objective variable; and
predicting the objective variable by using the prediction model generated for the selected first section.

18. An information processing method, comprising:
dividing time series data of an objective variable into a plurality of first sections based on values of the objective variable;
generating, based on time series data of an explanatory variable and the time series data of the objective variable, a plurality of prediction models in which the explanatory variable and the objective variable are associated, for the plurality of first sections;
selecting a first section from the plurality of first sections based on at least one of
the time series data of the explanatory variable and
the time series data of the objective variable; and
predicting the value of the objective variable by using the prediction model generated for the selected first section.

19. An information processing system, comprising:
a divider configured to divide time series data including an objective variable related to a volume of stored water at a hydroelectric power plant into a plurality of first sections based on values of the objective variable;
a model generator configured to generate, based on time series data of an explanatory variable related to an amount regarding weather and the time series data of the objective variable, a plurality of prediction models in which the explanatory variable and the objective variable are associated, for the plurality of first sections;
a selector configured to select a first section from the plurality of first sections based on at least one of
the time series data of the explanatory variable and
the time series data of the objective variable;
a predictor configured to predict the value of the objective variable by using the prediction model generated for the selected first section; and
a planner configured to make a power generation plan based on prediction values of the objective variable.
